(19) United States
(12) Patent Application Publication
(10) Pub. No.: US 2008/0151227 A1
(43) Pub. Date: Jun. 26, 2008

(54) Method for Determining a Sizing Agent Concentration, Particle Size and a Sizing Agent Particle Size Distribution in a Peper Pulp

(75) Inventors: Simon Champ, Ludwigshafen (DE); Hans-Peter Kaub, Altrip (DE); Jurgen Neumann, Bohl-Iggelheim (DE); Markus Schmid, Deidesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/913,820

(22) PCT Filed: May 15, 2006
(86) PCT No.: PCT/EP06/62316

§ 371 Date: Nov. 7, 2007

(30) Foreign Application Priority Data
May 17, 2005 (DE) 10 2005 023 326.0

(51) Int. Cl. G01N 21/00

(52) U.S. Cl. 356/73

(57) ABSTRACT

Method for determining the size concentration, the particle size and the particle size distribution of natural and/or synthetic sizes in a paper stock by staining a sample of the particles (Tᵢ) of the size with a fluorescent dye, light being radiated into the sample of fluorescent or fluorescently stained particles and scattered light and/or fluorescent light from the sample being recorded and evaluated, and use of this method for determining the particle size distribution of reactive size particles in the paper stock or in the white water of paper machines during papermaking.

The invention relates to a method for determining the size concentration, the particle size and the particle size distribution of natural and/or synthetic sizes in a paper stock or in the white water of a paper machine.

In the production of paper, it is of interest, for example, to analyze anionic trash particles in the paper stock with regard to their size distribution and amount. Anionic trash particles are generally hydrophobic and tacky. They originate, for example, from recycled wastepaper and, in the papermaking process, lead to deposits in the machines. In order to suppress or to eliminate the adverse effect of the anionic trash on the papermaking, fixing agents are metered into the paper stock. As a result of this, the anionic trash is bound to the cellulose fibers, and deposits in the machines are very substantially avoided. The amount of fixing agent required in each case is then determined with the aid of an analysis of the paper stock or of the white water for anionic trash particles.

Various methods are known for determining the size distribution of anionic trash particles in a paper stock. With conventional methods of investigation, for example, X-ray microanalysis, infrared spectrophotometry and gel permeation chromatography, as described in R. Wilken and J. Strauss, “Grundlegende Untersuchungen über klebende Verunreinigungen im wiederverwendeten Altpapier”, Mitteilungen aus dem Papiertechnischen Institut der Papiertechnischen Stiftung, Volume 11-12 (1984), page 292 et seq., in the overview, it is possible to determine the type of anionic trash particles, i.e. their chemical composition, in the laboratory. It is also possible to make qualitative statements about concentration and particle size distribution. However, these methods all have the disadvantage that they are relatively time-consuming and labor-intensive and are therefore not suitable for the direct monitoring of changes in anionic trash and the effect of additives on the binding of the anionic trash to the paper stock during the production cycle.

Another method for determining the particle size distribution of anionic trash particles is described in T. Kröhl, P. Lorencak, A. Gierulski, H. Eipel and D. Horn, “A new laser-optical method for counting colloidally dispersed pitch”, Nordic Pulp and Paper Research Journal, Volume 9 (1994), No. 1, page 26 et seq. In this method, anionic trash particles are stained with a fluorescent dye and isolated by hydrodynamic focusing. Thereafter, laser light is radiated into the sample comprising the isolated anionic trash particles, and fluorescent light emitted by them is recorded. From the intensity of the fluorescence signals, it is then possible to draw conclusions about the particle size distribution. However, this method gives a sufficiently accurate particle size distribution only when the sample either comprises only one particle type or comprises a plurality of particle types but these have approximately the same stainability for the fluorescent dye used and a comparable quantum efficiency. Since these preconditions are seldom met in practice, the fluorescence-optical measuring method described is not a method which is reliable in practice for determining the particle size distribution in a sample comprising a plurality of particles of different types. A further disadvantage is that a plurality of different particle varieties cannot be distinguished. Consequently, the addition furthermore cannot be adapted in type and amount to the respective conditions.

DE-A 40 40 463 discloses a measuring method for determining the number and size of resin particles in a paper stock, a paper stock suspension first being prepared, and the resin particles being separated therefrom by filtration, the resin particles being marked with a fluorescent dye, said particles then being isolated and excited to emit light, the light signals being detected and the signals being evaluated for counting and size determination of the resin particles. The fluorescent dye used is N-(n-butyl)-4-(n-butylamino)naphthalimide.

DE-A 197 00 648 discloses a method for determining the size distribution of at least two particle types (A_{K}) of fluorescent particles (Tᵢ) in a single sample, the particles (Tᵢ) in the sample being isolated and light being radiated into the sample along a predetermined direction of incidence, at least one scattered light intensity value (S(Tᵢ)) and at least one fluorescent light intensity value (F(Tᵢ)) of each particle (Tᵢ) being measured, the particles (Tᵢ) being coordinated in each case with a particle type (A_{K}) on the basis of the position of their pairs of values (S(Tᵢ),F(Tᵢ)) in a region (B_{K}) in a three-dimensional space (R) which is defined by the scattered light intensity values (S(Tᵢ)), the fluorescent light intensity values (F(Tᵢ)) and the frequency of the pairs of values (S(Tᵢ),F(Tᵢ)), each region (B_{K}) having at least one local maximum of the frequency of the pairs of values (S(Tᵢ),F(Tᵢ)) in the space (R) for the particle type (A_{K}), the relative frequency of the fluorescent light intensity values (F(Tᵢ)) being determined for each particle type (A_{K}), the relative particle size distribution for each particle type (A_{K}) being calculated from the relative frequency of the fluorescent light intensity values (F(Tᵢ)) for the corresponding particle type (A_{K}), the relative particle size distributions for the individual particle types (A_{K}) being normalized relative to one another with the aid of the position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ),F(Tᵢ)), and a common relative particle size distribution for the particles (Tᵢ) of all particle types (A_{K}) thus being formed.

This method is used in particular for determining the particle size distribution of hydrophobic anionic trash particles in the paper stock or in the white water of paper machines and is used for controlling the metering of fixing agents to the paper stock by producing a control signal corresponding to or coordinated with the common relative particle size distribution and carrying out the metering of the required amount of fixing agent on the basis of this control signal.

In the engine sizing of paper, at least one engine size is added to the paper stock and the latter is then drained on the wire of a paper machine with sheet formation. Suitable engine sizes are, for example, rosin size, modified rosin size and synthetic sizes, such as alkenylsuccinic anhydrides (ASA) and alkyldiketenes (AKD). ASA and AKD are also referred to as reactive sizes. The sizes are used in the form of aqueous dispersions in papermaking. Here, it is important for the sizes dispersed in water to be sufficiently retained by the cellulose fibers so that they are not deposited in the paper machines or do not accumulate in the white water.

It is the object of the present invention to determine the concentration, particle size and particle size distribution of dispersed sizes in a paper stock and in the white water of a paper machine.

The object is achieved, according to the invention, by a method for determining the size concentration, the particle size and the particle size distribution of natural and/or synthetic sizes in a paper stock or in the white water of a paper machine, if the particles (Tᵢ) of the size are stained with a fluorescent dye, the particles (Tᵢ) are isolated in the sample and light is radiated into the sample along a predetermined direction of incidence, at least one scattered light intensity value (S(Tᵢ)) and/or at least one fluorescent light intensity value (F(Tᵢ)) of each particle (Tᵢ) is measured, the particles (Tᵢ) are each coordinated with a particle type (A_{K}) on the basis of the position of their pairs of values (S(Tᵢ),F(Tᵢ)) in a region (B_{K}) in a three-dimensional space (R) which is defined by the scattered light intensity values (S(Tᵢ)), the fluorescent light intensity values (F(Tᵢ)) and the frequency of the pairs of values (S(Tᵢ),F(Tᵢ)), each region (B_{K}) having at least one local maximum of the frequency of the pairs of values (S(Tᵢ),F(Tᵢ)) in the space (R) for the particle type (A_{K}), the relative frequency of the fluorescent light intensity values (F(Tᵢ)) for each particle type (A_{K}) is determined, the relative particle size distribution for each particle type (A_{K}) is calculated from the relative frequency of the fluorescent light intensity values (F(Tᵢ)) for the corresponding particle type (A_{K}), the relative particle size distributions for the individual particle types (A_{K}) are normalized relative to one another with the aid of the position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ),F(Tᵢ)), and a common relative particle size distribution for the particles (Tᵢ) of all particle types (A_{K}) is thus formed.

Suitable sizes are natural and/or synthetic sizes, e.g. reactive size, rosin size, modified rosin sizes or polymer dispersions having sizing activity. The sizes are compounds which are dispersed in water and have, for example, particle sizes in the range from about 0.1 μm to 100 μm, preferably from 1 μm to 20 μm.

The most important reactive sizes for paper are alkyldiketenes and alkenylsuccinic anhydrides. They are used as engine sizes in the production of paper, board and cardboard. These substances are substantially C₁₄- to C₂₂-alkyldiketenes, such as stearyldiketene, palmityldiketene, behenyldiketene, oleyidiketene and mixtures of the diketenes. They are prepared, for example, by emulsification in water in the presence of cationic starch and an anionic dispersant under the action of shearing forces, cf. U.S. Pat. No. 3,223,544 and U.S. Pat. No. 3,130,118. Because of an excess of cationic starch relative to the anionic dispersant, the AKD dispersions thus prepared have a cationic charge.

Alkyldiketenes can also be used together with other sizes. Thus, for example, WO 94/05855 discloses that alkyldiketenes can be dispersed in a mixture of an aqueous suspension of a digested cationic starch and a finely divided aqueous polymer dispersion which is a size for paper. The resulting mixture is used as a size for paper. Aqueous, anionic AKD dispersions which are obtainable, for example, by dispersing AKD in water in the presence of anionic dispersants as the sole stabilizer are also known, cf. WO 00/23651.

Polymer sizes are described, for example, in JP-A 58/115 196, EP-B 257 412 and EP-B 276 770. They are substantially aqueous dispersions of copolymers which are prepared in the presence of starch or degraded starch. Suitable copolymers are, for example, copolymers of styrene and/or acrylonitrile and acrylates.

Alkenylsuccinic anhydrides are likewise used as engine sizes in industry in the production of paper and paper products. Examples of such sizes are the isomeric 4-, 5-, 6-, 7- and 8-hexadecenylsuccinic anhydrides, decenylsuccinic anhydride, octenylsuccinic anhydride, dodecenylsuccinic anhydride and n-hexadecenylsuccinic anhydride, cf. also C. E. Farley and R. B. Wasser, The Sizing of Paper, Second Edition, (3), Sizing With Alkenyl Succinic Anhydride, TAPPI PRESS, 1989, ISBN 0-89852-051-7.

Suitable natural sizes are rosin size and chemically modified rosin sizes, cf. E. Strazdins, Chapter 1, “Chemistry and Application of Rosin Size” in W. F. Reynolds (Ed.), “The Sizing of Paper”, Second Edition, Tappi Press (Atlanta, USA), 1989, pages 1 to 31 (ISBN 0-89852-051-7).

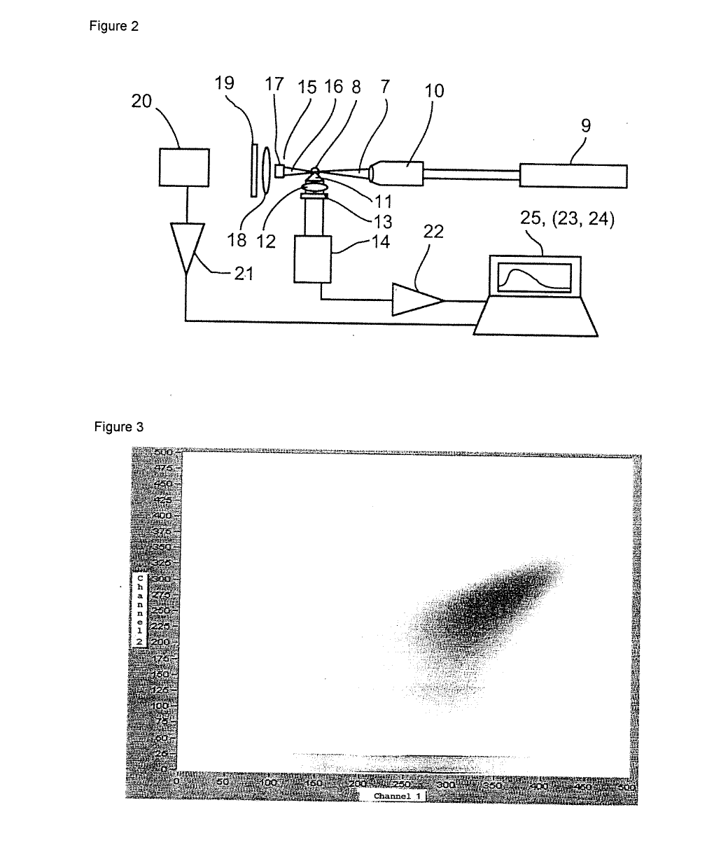

The apparatus shown in FIG. 2 is used for carrying out the method according to the invention. The method for determining the size distribution of sizes in a paper stock or in white water starts from at least two types (A_{K}) of fluorescent particles (Tᵢ) in a sample. Fluorescent particles are those size particles which fluoresce naturally or after staining with a fluorescent dye. The method according to the invention comprises at least the following steps:
(a) First, the particles (Tᵢ) in the sample are isolated. This is preferably effected by hydrodynamic focusing of the particles. In this procedure, a suspension of the particles to be investigated is continuously mixed together with a water stream (so-called envelope stream) and either allowed to fall freely or introduced into an envelope stream cell. The envelope stream flowing substantially faster than the suspension distributes the particles over a relatively long distance so that finally the particles are present predominantly as individual particles in the envelope stream.
   After the isolation of the particles, light is radiated into the sample along a specified direction of incidence. The light source used is preferably a laser.
(b) Thereafter, at least one scattered light intensity value (S(Tᵢ)) and at least one fluorescent light intensity value (F(Tᵢ)) is measured for each isolated particle (Tᵢ) transported past the light source, so that at least one pair of values (S(Tᵢ),F(Tᵢ)) per particle (Tᵢ) is obtained. Depending on the degree to which it is intended to eliminate random measuring errors, it is also possible to determine a plurality of pairs of values per particle. It is of course also possible to consider particles only in random samples if this is considered to be sufficiently informative. For measuring the scattered light and the fluorescent light, appropriate detectors are present at the periphery of the sample.
   In the method according to the invention, the forward scattered light of the sample is preferably recorded, i.e. the scattered light which is emitted from the sample in a cone around the direction of incidence of the light. It is advantageous to fade out the intense excitation light in the direction of incidence. The scattered light intensity values (S(Tᵢ)) is therefore preferably recorded in a hollow cone whose inner lateral surface makes an angle of at least 5° with the direction of incidence and whose outer lateral surface makes an angle of not more than 50° with the direction of incidence.
   For refining the measuring method, the scattered light measuring cone may also be divided into a plurality of cone layers, i.e. angle segments, which are then evaluated separately. In addition, a backward scattered signal or 900 scatter signal can also be recorded and evaluated.
(c) In the next step, each particle (Tᵢ) is coordinated with a particle type (A_{K}) on the basis of the position of its associated pair of values (S(Tᵢ),F(Tᵢ)) in a region (B_{K}) in a three-dimensional space (R), which is defined by the scattered light intensity values (S(Tᵢ)), the fluorescent light intensity values (F(Tᵢ)) and the frequency of the pairs of values (S(Tᵢ),F(Tᵢ)). Each region (B_{K}) is determined so that it contains at least one local maximum of the frequency of the pairs of values (S(Tᵢ),F(Tᵢ)) for a particle type (A_{K}). This distinction of the various particle types (A_{K}) is possible because use is made here of the fact that the intensity of the scattered light and of the fluorescent light depends in different ways on the particle type. A plot of the values of the scattered light intensity against the associated values of the fluorescent light intensity therefore generally leads to clearly distinguishable areas of measured values, i.e. a local frequency maximum of the pairs of values for the scattering and the fluorescence, an area corresponding to a certain particle type. From the position of the measured point (S(Tⱼ), F(Tⱼ)) for a certain particle (Tⱼ) in a certain area of measured points, it is therefore possible to determine its particle type.
(d) The relative frequency of the fluorescent light intensity values (F(Tᵢ)) is then determined, and the relative particle size distribution is calculated therefrom for each particle type (A_{K}). If desired, a calibration for absolute particle sizes can also be carried out here, which, however, requires a knowledge of a calibration factor specific to the particle type. This is relatively easy to realize after identification of the particles because, with the separation of the particle types, the troublesome effects of the different stainabilities and unlike quantum efficiencies of the various particle types have also been eliminated. However, because of these differences, a common size distribution for all particle types present in the sample cannot be derived from the relative particle size distributions for the various particle types by conventional methods.
(e) The relative particle size distributions for the individual particle types (A_{K}) are then normalized relative to one another with the aid of the position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ),F(Tᵢ)). A common relative particle size distribution for all particle types (A_{K}) is then formed therefrom. The normalization can be carried out in principle by any desired method, provided that the physical conditions are appropriately determined.

Preferably, however, the following further steps are carried out in order to obtain this common particle size distribution:
(a) A scattered light region (SLB(A_{K})) of scattered light intensity values (S(Tᵢ)) is chosen for each particle type (A_{K}), which region is of a predetermined size and in which the frequency of the pairs of values (S(Tᵢ),F(Tᵢ)) of the particle type (A_{K}) has at least one local maximum, i.e. the density of the measured values is also a maximum at least locally. The determination of the region of greatest measured value density or measured value frequency can be effected with the aid of a suitable calculation rule, expediently in a computer to which the pairs of values are made available, but it is also possible to carry out optical estimation by eye on a screen on which the scattered light intensity values (S(Tᵢ)) are plotted against the fluorescent light intensity values (F(Tᵢ)). The size of the region is determined beforehand, for example to a few percent of the scattered light intensity value (S(Tᵢ)) which approximately represents the center of the region of maximum measured value density. Finally, the chosen region must simply be sufficiently large to permit a reliable calculation of the mean value by including sufficient pairs of values, and must be sufficiently small to keep the influence of random measuring errors as low as possible.
(b) A scattered light region (SLB) of scattered light intensity values (S(Tᵢ)) of a predetermined size having an upper and a lower limit of the region is then determined, whose mean value of the upper and the lower limit of the region is equal to the mean value of the mean values of the scattered light intensity values (S(Tᵢ)) in the respective scattered light regions (SLB(A_{K})). The scattered light region (SLB) now determined comprises the regions of greatest or at least very great measured value density for the various measured value areas, i.e. particle types. This scattered light region which is standard for all particle types must be determined in order to normalize the fluorescence signals of the various particle types relative to one another, i.e. in order to have a measure of the different stainabilities and quantum efficiencies of the particle types. In many cases, the scattered light regions of greatest measured value density (SLB(A_{K})) for the individual particle types (A_{K}) will already substantially overlap one another and thus form the common scattered light region (SLB). Its size, i.e. the region of scattered light intensity values (S(Tᵢ)) which is spanned by it, is predetermined. The above statements on the scattered light regions (SLB(A_{K})) apply in a corresponding manner in this context.
   Instead of the relatively exact steps (a) and (b), the scattered light region (SLB) can also be simply directly chosen without previously selecting scattered light regions (SLB(A_{K})) for the individual particle types (A_{K}) and calculating the scattered light mean values thereof. In this case, an estimate is made as to which measured value region the scattered light region (SLB) has to cover approximately in order to comprise the points of greatest measured value density for all different particle types (A_{K}). Depending on the integral requirements with regard to the accuracy of the subsequent normalization, it is possible to adopt a more or less exact procedure and even to choose a scattered light region (SLB) which just does not comprise the point of greatest measured value density for one or more particle types.
(c) In the next step, in each case a fluorescent light region (FLB(A_{K})) of fluorescent light intensity values (F(Tᵢ)) for each particle type (A_{K}) of predetermined size is determined, the pairs of values (S(Tᵢ),F(Tᵢ)) of which region are also within the scattered light region (SLB). Here, the fluorescent light intensity values (F(Tᵢ)) for each particle type (A_{K}), i.e. for each measured value area, which belong to the scattered light intensity values (S(Tᵢ)) in the scattered light region (SLB) are determined.
(d) The mean value (M(FLB(A_{K}))) of the fluorescent light intensity values (F(Tᵢ)) in the respective fluorescent light region (FLB(A_{K})) is then determined for each particle type (A_{K}).
(e) A normalization factor (N(A_{K})), based on any desired particle type (A₁), is calculated therefrom for each particle type (A_{K}), where: (N(A_{K}))=(M(FLB(A_{K})))/(M(FLB(A₁))).
(f) As a final step, the relative particle size distributions of the particle types (A_{K}) are related to one another with the aid of the normalization factors (N(A_{K})). Thus, a common particle size distribution for all particle types (A_{K}) present in the sample has been obtained from the relative size distributions of the various particle types (A_{K}), which distributions are not comparable with one another. With a knowledge of the relationship between fluorescence intensity signal and absolute particle size for a certain particle type present in the sample investigated, it is also possible to obtain an absolute particle size distribution therefrom. In the above example of papermaking, this knowledge can be used for choosing and metering an additive for the finely divided binding of anionic trash to the paper stock.

In a preferred embodiment of the method according to the invention, pairs of values (S(Tᵢ),F(Tᵢ)) in the scattered light region (SLB) which deviate from the respective mean value (M(FLB(A_{K}))) beyond a degree of deviation specified for each particle type (A_{K}) are excluded from the evaluation. This elimination of presumable or actual incorrect measurements can take place in principle at any stage of the method, but preferably during the assignment of the particles (Tᵢ) to a certain particle type. If it is found that the pair of values (S(Tⱼ),F(Tⱼ)) of a certain particle (Tⱼ) is substantially outside every distinguishable measured value area, it is expediently eliminated for the further evaluation. Consequently, random measuring errors of the scattered light and fluorescent light measurement can propagate themselves only to a limited extent in the normalization factors (N(A_{K})). Which deviation is taken to be acceptable in a certain measured value area, i.e. for a certain particle type (A_{K}), depends on the circumstances of the individual case, in particular on how accurately the random errors can be estimated and accordingly how accurately it is possible to decide whether a measured value is erroneous or not.

The method according to the invention is preferably applied to water-dispersed particles of reactive sizes (Tᵢ). These particles are obtained, for example, by taking a paper stock sample or white water sample from a paper machine and separating off the free size particles (e.g. particles of rosin size or chemically modified rosin size, preferably particles of alkenylsuccinic anhydrides or alkyldiketenes) therefrom by filtration. The resulting particles of a practically water-insoluble size are then stained with a, preferably lipophilic, fluorescent dye, isolated in a medium, such as water, and, as described, investigated optically. Other particles which may be present in addition to size particles in the paper stock are also stained under certain circumstances. However, these particles absorb the added dye at a different rate and/or comprise it in a different concentration, so that it is possible to distinguish the stained size particles from the other, likewise stained dispersed particles. For example, suitable fluorescent dyes are:

N-(n-butyl)-4-(n-butylamino)naphthalimide (Fluorol 7GA),
dye of Color Index (C.I.) number 40662 (Celluflor),
dye of C.I. number 45400 (Eosin B),
3,3-ethoxydicarbocyanine iodide,
trisodium salt of 8-hydroxy-1,3,6-pyrenetrisulfonic acid,
6-nitro-1,3,3-trimethyl-[2H]-1-benzopyran-2,2-indole (Merocyanin 540),
2-[6-(diethylamino)-3-diethylimino-3H-xanthen-9-yl)benzoic acid (Rhodamin B).

In the method according to the invention, the particles (T(i)) can be stained with a plurality of different fluorescent dyes, the different dyes emitting, in different wavelength ranges, fluorescent light which is recorded by one detector per fluorescence band. These dyes may be excitable either with the same or only with different excitation frequencies. In the latter case, light sources having correspondingly different frequencies are then used, it being necessary for the focuses of the light sources either to overlap or to be close together so that the different recorded fluorescence signals also originate from the same individual particles. Thus, the particle types (A_{K}) can be distinguished even more reliably from one another with the aid of different fluorescence frequencies.

The apparatus for determining the size distribution of at least two types (A_{K}) of fluorescent isolated particles (Tᵢ) in a sample has at least one light source, for example a laser, which emits a focused light beam along an axis of incidence into the sample, the focus of the light beam preferably being in the sample, at least one device for recording at least one scattered light intensity value (S(Tᵢ)) for each particle (Tᵢ), at least one device for recording at least one fluorescent light intensity value (F(Tᵢ)) for each particle (Tᵢ), and an evaluation unit to which the scattered light intensity values (S(Tᵢ)) and the fluorescent light intensity values (F(Tᵢ)) for each particle (Tᵢ) are fed and which is designed in such a way that it can carry out at least the following evaluation steps:
(a) assignment of the particles (Tᵢ) to a particle type (A_{K}) with the aid of the position of their pairs of values (S(Tᵢ),F(Tᵢ)) in a region (B_{K}) in a three-dimensional space (R) which is defined by the scattered light intensity values (S(Tᵢ)), the fluorescent light intensity values (F(Tᵢ)) and the frequency of the pairs of values (S(Tᵢ),F(Tᵢ)), each region (B_{K}) having at least one local maximum of the frequency of the pairs of values (S(Tᵢ), F(Tᵢ)) in the space (R) for the particle type (A_{K});
(b) determination of the relative frequency of the fluorescent light intensity values (F(Tᵢ)) for each particle type (A_{K});
(c) calculation of the relative particle size distribution for each particle type (A_{K}) from the relative frequency of the fluorescent light intensity values (F(Tᵢ)) for the corresponding particle type (A_{K});
(d) normalization of the relative particle size distributions for the individual particle types (A_{K}) with the aid of the relative position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ),F(Tᵢ)) relative to one another; and
(e) formation of a common relative particle size distribution for all particle types (A_{K}).

An apparatus shown schematically in FIG. 2 and comprising an evaluation unit (23, 24, 25) is preferred, which evaluation unit can carry out, for normalization of the relative particle size distributions for the individual particle types (A_{K}) relative to one another in step (d), also at least the following steps:
(a) selection of a scattered light region (SLB(A_{K})) of scattered light intensity values (S(Tᵢ)) having a predetermined size for each particle type (A_{K}), in which the frequency of the pairs of values (S(Tᵢ),F(Tᵢ)) of the particle type (A_{K}) has at least one local maximum;
(b) determination of a scattered light region (SLB) of scattered light intensity values (S(Tᵢ)) of a predetermined size having an upper and a lower limit of the region, whose mean value of the upper and the lower limit of the region is equal to the mean value of the mean values of the scattered light intensity values (S(Tᵢ)) in the respective scattered light regions (SLB(A_{K})). As already described in the method above, the steps (a) and (b) can also be replaced by a single step in which a scattered light region (SLB) is selected without prior determination of the scattered light regions (SLB(A_{K})) specific to the particle type. The above remarks are applicable for the choice of the size and position of the scattered light region (SLB);
(c) determination of a fluorescent light region (FLB(A_{K})) of fluorescent light intensity values (F(Tᵢ)) having a predetermined size for each particle type (A_{K}), whose pairs of values (S(Tᵢ),F(Tᵢ)) are also within the scattered light region (SLB);
(d) determination of the mean value (M(FLB(A_{K}))) of the fluorescent light intensity values (F(Tᵢ)) in the fluorescent light region (FLB(A_{K})) for each particle type (A_{K});
(e) formation of a normalization factor (N(A_{K})) for each particle type (A_{K}), based on any desired particle type (A₁), where: (N(A_{K}))=(M(FLB(A_{K})))/(M(FLB(A_{K}))); and
(f) relation of the relative particle size distributions of the particle types (A_{K}) to one another with the aid of the normalization factors (N(A_{K})).

The explanations given above for the corresponding steps of the method according to the invention are applicable here in context.

The device for recording at least one scattered light intensity value (S(Tᵢ)) for each particle (Tᵢ) is preferably designed and arranged in the apparatus in such a way that the scattered light intensity values (S(Tᵢ)) are recorded in a hollow cone whose inner lateral surface makes an angle of at least 5° with the axis of incidence of the light source (10), and whose outer lateral surface makes an angle of not more than 50° with this axis.

Also preferred is an apparatus comprising an evaluation unit which excludes from the evaluation those pairs of values (S(Tᵢ),F(Tᵢ)) in the scattered light region (SLB) which deviate from the respective mean value (M(FLB(A_{K}))) beyond a degree of deviation specified for each particle type (A_{K}). Which deviation is regarded as tolerable, i.e. as probably not being based on a measuring error, depends on the circumstances of the individual case. In this context, reference is made once again to the corresponding explanations of the method.

The method according to the invention and the apparatus described are preferably suitable for determining the particle size, the particle size distribution and the concentration of size particles in papermaking. The size particles present in the paper stock or in the white water of paper machines can be determined therewith. In particular, they can be used for controlling or for regulating the metering of sizes to the paper stock in paper machines, in particular of reactive sizes, in such a way that overmetering or undermetering is avoided. This control is effected on the basis of a control signal which is output as a result of the common relative particle size distribution for the various size particles. Thus, the method according to the invention is used for controlling the metering of aqueous dispersions of sizes to the paper stock of paper machines, a control signal corresponding to or coordinated with the common relative particle size distribution being generated and the metering being controlled on the basis of this control signal. The product quality can thus be kept virtually constant during the papermaking.

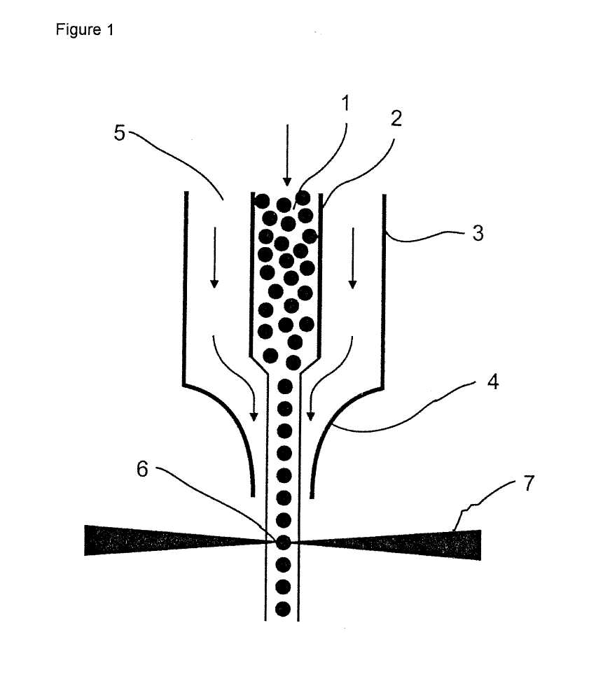

FIG. 1 shows a schematic diagram of an apparatus for isolating particles in a sample. Isolation of the particles to be investigated optically is necessary in the context of the present invention in order to be able to be certain that each individual measured value, i.e. each pair of values (S(Tᵢ),F(Tᵢ)), belongs to a certain particle Tᵢ. Thus, in the method of the present invention, the influences of different stainabilities and quantum efficiencies can be estimated and eliminated. In the apparatus according to FIG. 1, a sample stream 1 comprising the particles to be investigated is passed through a capillary 2 into an envelope stream chamber 3, at the end of which a nozzle 4 is present. An envelope stream, for example simply water, is introduced into the chamber 3 via a hollow cylindrical pipe 5 surrounding the capillary 2. The envelope stream from the pipe 5 has a substantially higher velocity than the sample stream 1 in the capillary 2. At the end of the capillary 2, the sample stream 1 and the envelope stream from the pipe 5 mix, the particles in the sample stream 1 being distributed over a longer distance owing to the higher velocity of the envelope stream, i.e. the sample stream being diluted with respect to the particles to be investigated. This principle is referred to as hydrodynamic focusing. The dilute sample jet emerging from the nozzle 4 therefore comprises the sample particles virtually completely isolated from one another. If a focused light beam 7, for example a laser beam, is then directed at any desired measuring location 6 in this jet, an individual particle is virtually always observed in the sample stream. In the context of the present invention, this principle of hydrodynamic focusing is particularly suitable for isolating the particles in the sample.

FIG. 2 shows a diagram illustrating the principle of a measuring setup according to the present invention. A laser 9 delivers excitation light to an objective 10 which focuses the laser light onto a sample 8. The focus is preferably in the sample 8 but may also be outside it. All that is important is that the intensity of the excitation light in the sample be sufficiently high and that the light cone of the excitation light not be so broad that a plurality of sample particles are simultaneously excited. Via a lens 18, a photomultiplier 20 collects the excitation light scattered forward in the sample 8 and passes on the scattered light intensity values or electrical signals proportional thereto via an amplifier 21 to a computer 25. Here, upstream of the photomultiplier 20, is a beam stopper 17 and an interference filter 19, the former before and the latter after the lens 18. The interference filter is tuned to the laser and allows through only light having the wavelength emitted by the laser. The interference filter 19 is optional. It generally improves the signal/noise ratio. The beam stopper 17 has the function of filtering out the intense fraction of excitation light passing through unscattered in the conical scattered light beam 16 arriving from the sample 8. Preferably, approximately one core cone having an opening angle of 5° is filtered out. The measurement of the scattered light is otherwise preferably effected in a hollow cone whose inner lateral surface makes an angle of at least 5° with the cone axis, and whose outer lateral surface makes an angle of not more than 50° with the cone axis. Accordingly, the apparatus according to the invention as shown in FIG. 2 comprises a photomultiplier 14 for registering the fluorescent light 11 from the sample 8. As shown in FIG. 2, the fluorescent light from the sample is preferably recorded in a 90° direction to the incident light beam. A lens 12 and an edge filter 13 are also present in the beam path for recording the fluorescent light. The photomultiplier 14 sends fluorescent light intensity signals via an amplifier 22 to the computer 25. This comprises one multichannel analyzer 23 and 24 each for the scattered light and for the fluorescent light, which analyzer sorts the intensity values.

### EXAMPLES

The evaluation and obtaining of results are to be illustrated for the example of an aqueous dispersion of a size sample of a reactive size based on ASA, and in particular a C₁₋₈-alkenylsuccinic anhydride which was stabilized with starch (Amylofax® 00). An engine size was prepared by homogenizing ASA in an aqueous solution which comprised 2.5% by weight of said starch. The concentration of ASA in the aqueous, starch-containing dispersion was 12 mg/l.

In each case 25 ml were taken as a sample from the ASA dispersed in water and mixed with 1 ml of the fluorescent dye N-(n-butyl)-4-(n-butylamino)naphthalimide (Fluorol® 7GA, 40 mg/l in ethanol) and stained for 4 minutes. The ASA particles dispersed in water were stained during this procedure, but not the crill fraction of cellulose fibers. The measuring time was 300 s.

In FIG. 3, the number of measured particles (degree of staining) is plotted against the intensity of the fluorescence (channel 1) and the forward scattering (channel 2). The ASA populations are clearly evident in contrast to the population located at the lower edge. This population originates substantially from unused dye and electronic noise.

For determining the working range of the method of analysis, a concentration series (0-20 mg/l) of starch-stabilized ASA in water was prepared on the basis of the concentration of 10 mg/l used.

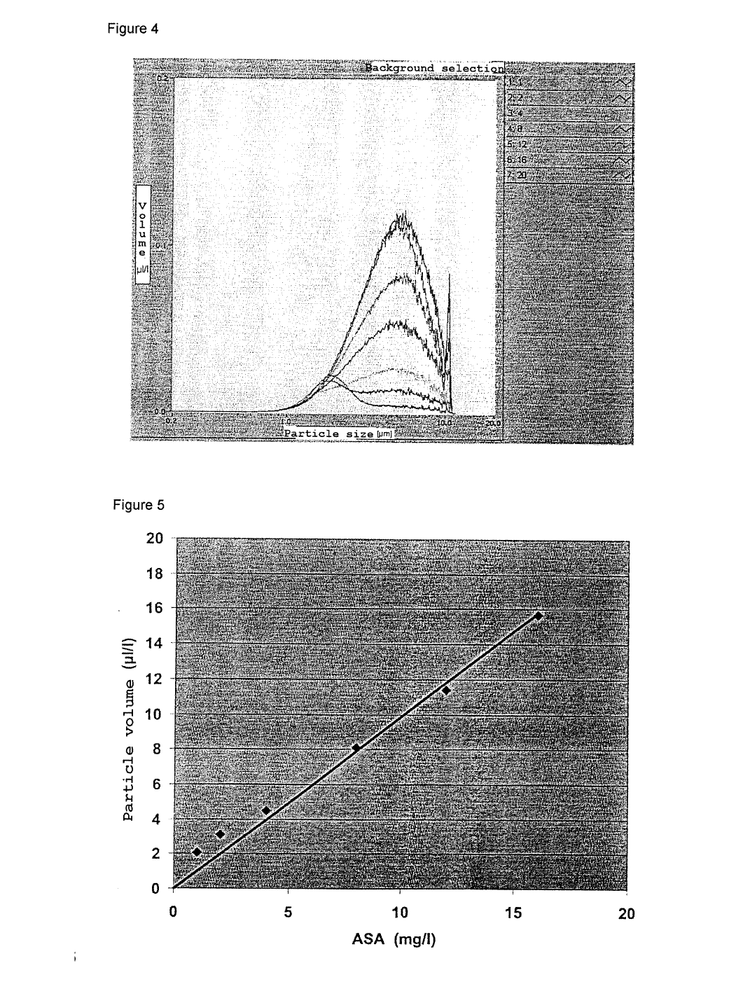

The result of the measurements for the concentration series is shown in FIG. 4, from which the volume distribution of the various concentrations of ASA is evident. In general, it can be seen that the volume distribution increases with increasing concentration. Between 16 and 20 mg/l of ASA, no further increase in the volume distribution is detectable.

If the integral below the distribution curves is now plotted against the ASA concentration weighed in, a straight line with a slope of 0.99 is obtained, as shown in FIG. 5.

At the concentration of 20 mg/l, the ASA weighed in could no longer be completely recovered. The working range for this method is therefore between 0 and 16 mg/l of ASA.

In order to determine the retention of the reactive size during use, a paper stock having a solids content of 8 g/l was first prepared from an aqueous suspension of birch/pine sulfate in the weight ratio 70/30, having a freeness of 35°SR, and 20% of calcium carbonate (Hydrocarb) as a filler. 500 ml of the paper stock suspension were then initially taken in a dynamic drainage jar (pore size 80 μm), in each case a formulation comprising the above-described 0-20 mg/l of ASA was added and, after an action time of 1 minute, 100 ml of the filtrate were taken off. For the analysis with the apparatus described in FIG. 2, in each case 25 ml of the filtrate were mixed with 1 ml of Fluorol® 7GA (40 mg/l), stained for 4 minutes and then measured for 300 s.

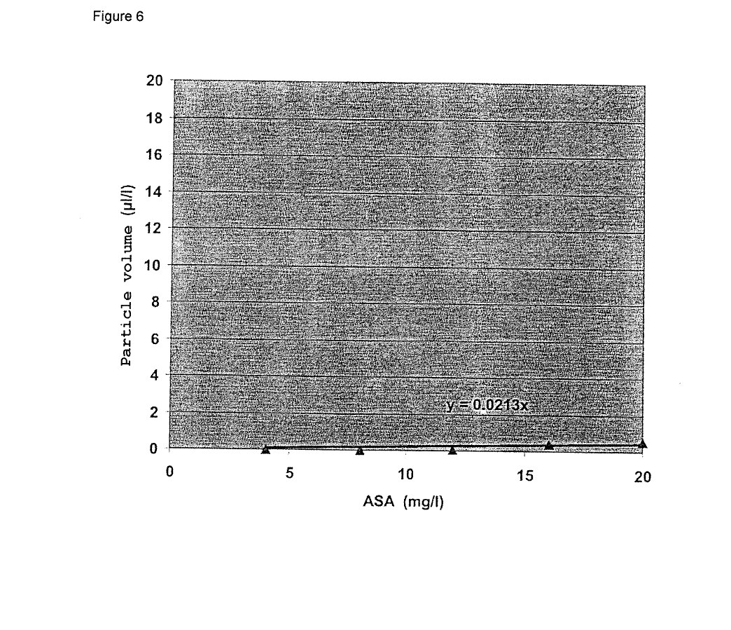

FIG. 6 shows the result of this measurement series. The slope of the straight line corresponds to 0.02, i.e. the filtrate comprised about 2% of the amount of ASA added to the paper stock. This corresponds to a retention of 98% of ASA on the paper stock.

The present invention therefore provides a method for determining the relative and absolute particle size distribution of various particles in a sample, which method is simple and rapid and is therefore particularly suitable for online operation.

1: A method for determining the size concentration, the particle size and the particle size distribution of natural and/or synthetic sizes in a paper stock or in the white water of a paper machine, wherein the particles (Tᵢ) of the size are stained with a fluorescent dye, the particles (Tᵢ) are isolated in the sample and light is radiated into the sample along a predetermined direction of incidence, at least one scattered light intensity value (S(Tᵢ)) and/or at least one fluorescent light intensity value (F(Tᵢ)) of each particle (Tᵢ) is measured, the particles (Tᵢ) are each coordinated with a particle type (A_{K}) on the basis of the position of their pairs of values (S(Tᵢ),F(Tᵢ)) in a region (B_{K}) in a three-dimensional space (R) which is defined by the scattered light intensity values (S(Tᵢ)), the fluorescent light intensity values (F(Tᵢ)) and the frequency of the pairs of values (S(Tᵢ),F(Tᵢ)), each region (B_{K}) having at least one local maximum of the frequency of the pairs of values (S(Tᵢ),F(Tᵢ)) in the space (R) for the particle type (A_{K}), the relative frequency of the fluorescent light intensity values (F(Tᵢ)) for each particle type (A_{K}) is determined, the relative particle size distribution for each particle type (A_{K}) is calculated from the relative frequency of the fluorescent light intensity values (F(Tᵢ)) for the corresponding particle type (A_{K}), the relative particle size distributions for the individual particle types (A_{K}) are normalized relative to one another with the aid of the position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ),F(Tᵢ)), and a common relative particle size distribution for the particles (Tᵢ) of all particle types (A_{K}) is thus formed.

2: The method according to claim 1, wherein, for normalizing the relative particle size distributions for the individual particle types (A_{K}), a scattered light region (SLB) of scattered light intensity values (S(Tᵢ)) of predetermined magnitude with an upper and a lower limit of the region is chosen, in which region the frequency of the pairs of values (S(Tᵢ),F(Tᵢ)) has at least one local maximum for all particle types (A_{K}), a fluorescent light region (FLB(A_{K})) of fluorescent light intensity values (F(Tᵢ)) is determined for each particle type (A_{K}) of predetermined magnitude, whose pairs of values (S(Tᵢ),F(Tᵢ)) are also in the scattered light region (SLB), a mean value (M(FLB(A_{K}))) of the fluorescent light intensity values (F(Tᵢ)) in the fluorescent light region (FLB(A_{K})) is determined for each particle type (A_{K}), a normalization factor (N(A_{K})), based on a particle type (A₁) is formed for each particle type (A_{K}), where (N(A_{K}))=(M(FLB(A_{K})))/(M(FLB(A_{K}))), and the relative particle size distributions of the particle types (A_{K}) are related to one another with the aid of the normalization factors (N(A_{K})).

3: The method according to claim 2, wherein the scattered light region (SLB) is determined by choosing in each case a scattered light region (SLB(A_{K})) of scattered light intensity values (S(Tᵢ)) for each particle type (A_{K}) of predetermined magnitude in which the frequency of the pairs of values (S(Tᵢ),F(Tᵢ)) has at least one local maximum for the particle type (A_{K}), and setting the mean value of the upper and the lower limit of the scattered light region (SLB) equal to the mean value of the mean values of the scattered light intensity values (S(Tᵢ)) in the scattered light regions (SLB(A_{K})).

4: The method according to claim 2, wherein those pairs of values (S(Tᵢ), F(Tᵢ)) in the scattered light region (SLB) which deviate from the respective mean value (M(FLB(A_{K}))) beyond a degree of deviation specified for each particle type (A_{K}) are excluded from the evaluation.

5: The method according to claim 1, wherein the isolation of the particles (Tᵢ) is effected by hydrodynamic focusing.

6: The method according to claim 1, wherein the particles (Tᵢ) are marked with at least one fluorescent dye, preferably N-(n-butyl)-4-(n-butylamino)naphthalimide.

7: The method according to claim 1, wherein the recorded scattered light intensity values (S(Tᵢ)) lie in a forward hollow scattering cone whose inner lateral surface makes an angle of at least 5° with the direction of the incidence of the light into the sample and whose outer lateral surface makes an angle of not more than 50° with this direction.

8. (canceled)

9: A method for controlling the metering of aqueous dispersions of sizes to a paper stock of paper machines, comprising generating a control signal corresponding to or coordinated with a common relative particle size distribution according to a method of claim 1 and controlling the metering on the basis of this control signal.
